(19) United States
(12) Patent Application Publication
(10) Pub. No.: US 2023/0009151 A1
(43) Pub. Date: Jan. 12, 2023

(54) Compact Smoke Infuser Apparatus

(71) Applicant: Haishan Deng, Shenzhen (CN)

(72) Inventor: Haishan Deng, Shenzhen (CN)

(21) Appl. No.: 17/372,462

(22) Filed: Jul. 11, 2021

(51) Int. Cl. A23L 5/30; A23L 27/27

(52) U.S. Cl. CPC A23L 5/30; A23L 27/27

(57) ABSTRACT

The present disclosure provides a compact portable smoke infuser apparatus having a U-shaped airway for guiding a flow of smoke between a combustion chamber inlet and an outlet for a hose attachment. The airway is built into a detachable enclosure attached to a main housing body which can be removed for ease of cleaning. When attached, the enclosure rests in line with a fan and motor assembly that generates the airflow. The efficient design allows a low power motor rate which increase the battery life of the apparatus.

### FIELD OF INVENTION

The present invention relates generally to portable smoke infuser devices. More specifically, the present invention relates to a portable smoke infuser having a compact airway design.

### BACKGROUND

Portable smoke infusers are devices which enable a stream of smoke to be generated from a burning combustible substance which is placed in a chamber with one or more fans or other suction means generating a pumping air flow to direct the smoke produced by the substance through the device and out of a nozzle to infuse a substance with a smoky flavour.

Such devices can be highly useful and employed in a surprisingly large number of situations, usually in the preparation of food such as spices, ice-cream, salads, and also in the preparation of drinks such as coffee, cocktails. Portable devices can infuse practically anything, in contrast to traditional bulkier smoke infusers.

There are however a number of limiting factors in current portable smoke infuser design. Firstly, the design of the airway between the smoke inlet and outlet is generally not very sophisticated, leading to an unnecessary amount of space being taken up and for the infusers to be larger than they need to be. Airways are also designed with little regard for flow dynamics of the pumped smoke, leading to turbulence and poor flow rate compared to what could be achieved with a better designed airway.

This leads to another issue which is the battery life of the smoke infuser. Current designs, which are generally powered by disposable batteries, use high power fan or pumping units to ensure smoke is passed through the device airway quickly. This limits battery life.

Finally, as the devices generally rely upon combustion of a burnable substance such as wood chippings in a chamber of the device, the device needs regular cleaning. Current designs do not facilitate easy removal and cleaning of the airways in between uses.

It is within this context that the present invention is provided.

### SUMMARY

The present disclosure provides a compact portable smoke infuser apparatus having a U-shaped airway for guiding a flow of smoke between a combustion chamber inlet and an outlet for a hose attachment. The airway is built into a detachable enclosure attached to a main housing body which can be removed for ease of cleaning. When attached, the enclosure rests in line with a fan and motor assembly that generates the airflow. The efficient design allows a low power motor rate which increase the battery life of the apparatus.

Thus, according to one aspect of the present disclosure there is provided a smoke infuser apparatus, comprising: a main housing; a power unit disposed within the main housing; a motor unit disposed within the main housing, the motor unit being connected to the power unit and configured to turn a shaft extending out of the main housing; a control interface disposed on an exterior wall of the main housing for controlling a power supply from the power unit to the motor unit; a fan unit configured to be mounted to the shaft.

The apparatus further comprises a detachable enclosure configured to attach to the main housing so as to cover the shaft-mounted fan unit, the enclosure comprising an exterior chamber configured to receive and hold combustible matter, the chamber having a perforated floor for smoke to flow through, the enclosure further comprising an inlet for receiving smoke from the chamber, an outlet for directing expelled smoke, and a U-shaped airway for directing a flow of smoke between the inlet and the outlet.

In some embodiments, the enclosure is formed of a first part configured to attach to the main housing to form a rear wall of the enclosure and a second part comprising the exterior chamber and configured to be mounted on the first part to form a front wall of the enclosure.

In some embodiments, the enclosure comprises an internally disposed platform underneath the perforated floor of the exterior chamber for catching burned matter.

In some embodiments, when installed upon the main housing, the smoke inlet of the enclosure, the fan unit, and the motor are in line with one another along a shared axis.

In some embodiments, the outlet forms a mount for a hosepipe, and wherein the apparatus further comprises a hosepipe configured to be mounted to the outlet.

The hosepipe may have a nozzle for directing a flow of expelled smoke.

In some embodiments, the perforated floor is a removable wire or metal mesh.

In some embodiments, the control interface consists of a power button.

In some embodiments, the motor is set to rotate the shaft at a single pre-determined speed upon actuation of the power button.

In some embodiments, one or more fan blades of the fan unit are formed of fibreglass.

### BRIEF DESCRIPTION OF THE DRAWINGS

Various embodiments of the invention are disclosed in the following detailed description and accompanying drawings.

FIG. 1 illustrates an isometric view of a first example configuration of the disclosed smoke infuser apparatus with a hose attachment installed on the smoke outlet.

FIG. 2 illustrates an isometric view of a second, more compact configuration of the disclosed smoke infuser apparatus enabled by the disclosed airway design.

FIG. 3 illustrates a second isometric view of the first example configuration without the hose attachment installed.

FIG. 4 illustrates an exploded view of the detachable enclosure, fan unit, and motor shaft extending from the main housing.

FIG. 5 illustrates an isometric view of a first part of the detachable enclosure including the combustion chamber and a platform for catching burned matter.

FIG. 6 illustrates an isometric view of a second part of the detachable enclosure with a fan unit placed to create an airflow within the enclosure.

FIG. 7 illustrates a second isometric view of the second part of the detachable enclosure and the fan unit.

FIG. 8 illustrates a cutaway view of the entire infuser apparatus assembled together to show the placement of the internal components.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure is directed to a portable smoke infuser apparatus having a specially designed airway within a detachable enclosure which is configured to efficiently direct smoke generated by a combustion chamber through the apparatus and out of an outlet that can be attached to a hose to direct a flow of smoke as desired by a user.

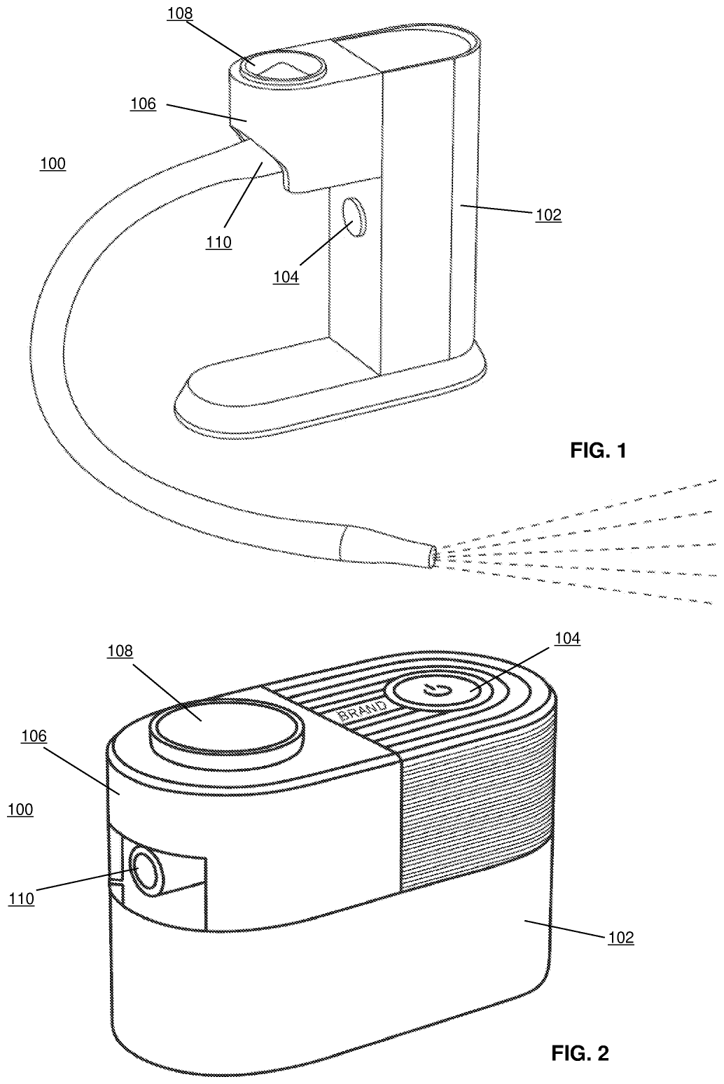

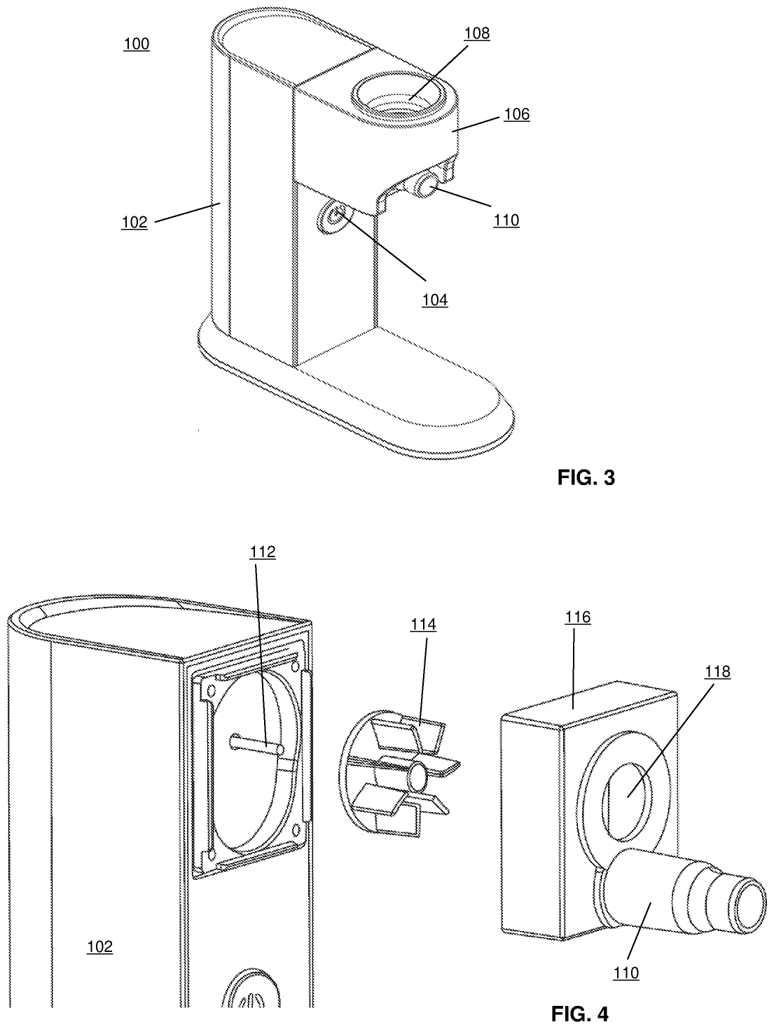

Referring to FIGS. 1 to 3, first (FIG. 1, FIG. 3) and second (FIG. 2) example configurations of the disclosed smoke infuser 100 are shown.

Both configurations comprise a main housing 102, a power unit and motor unit disposed within the main housing—for example a standard DC motor may be connected to a power unit comprising a set of disposable or rechargeable batteries. The power unit and motor assembly are for the purposes of turning shaft and a mounted fan to generates an airflow to direct smoke within the device.

A low charge power unit is suitable for the disclosed apparatus due to the efficiency of the airflow generated by the design, allowing a smaller number of batteries to be used than in known portable smoke infusers.

Additionally, the motor may be a single speed motor set at an intentionally low speed, as this has been found to remain effective in combination with the disclose airflow design. This allows for further power saving.

A control interface such as a single power button 104 may be disposed on an exterior wall of the main housing for controlling a power supply from the power unit to the motor unit.

The apparatus further comprises a detachable enclosure 106 configured to attach to the main housing 102 so as to cover the shaft-mounted fan unit. The enclosure comprises an exterior combustion chamber 108 configured to receive and hold combustible matter such as wood chippings.

The chamber has a perforated floor such as a wire mesh for smoke to flow through. The wire mesh may for example be a removable steel mesh to allow for easy cleaning in between uses.

The enclosure 106 further comprises an inlet for receiving smoke from the chamber floor and an outlet 110 for directing expelled smoke. The inlet and outlet are connected by a U-shaped airway through which flow is generated by the turning of the fan unit.

These workings are illustrated in FIGS. 4 to 7.

In particular, FIG. 4 shows an exploded view of the main housing 102, with the shaft 112 from the motor extending out of the housing for fan unit 114 to be mounted on.

The fan unit 114 is then covered by a first part 116 of the detachable enclosure 106 which comprises the smoke inlet 118 and outlet 110.

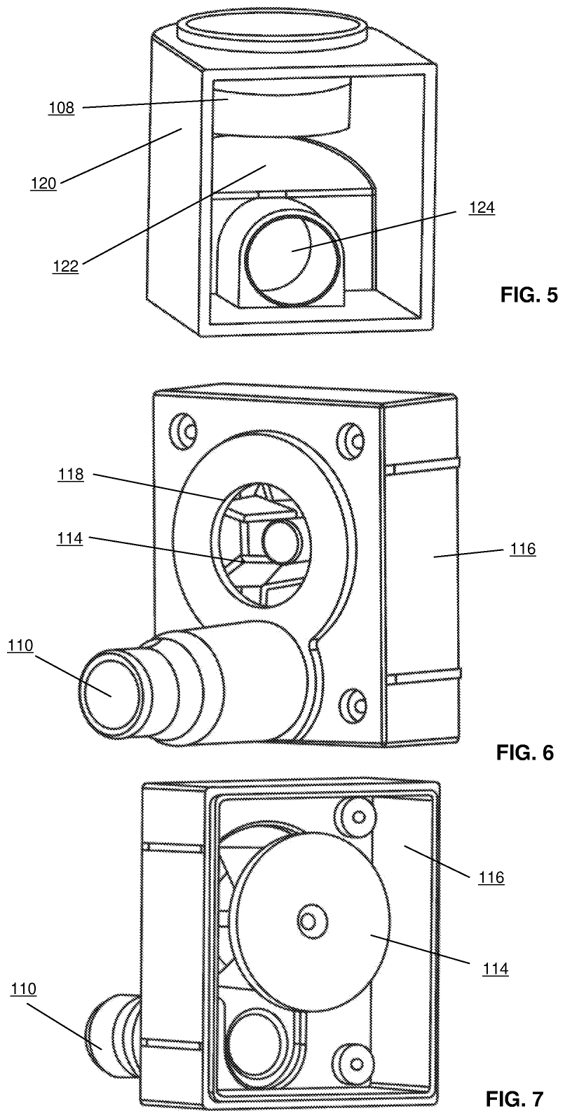

FIG. 5 shows the second part 120 of the detachable enclosure 106 which comprises the combustion chamber 108 with the perforated floor and which has a platform 122 beneath it to catch burned matter such as wood chipping ash. This further facilitates cleaning of the apparatus in between uses.

Opening 124 is configured to receive outlet 110 nozzle as the second part 120 of the enclosure is placed over the first part 116 to form a sealed airway.

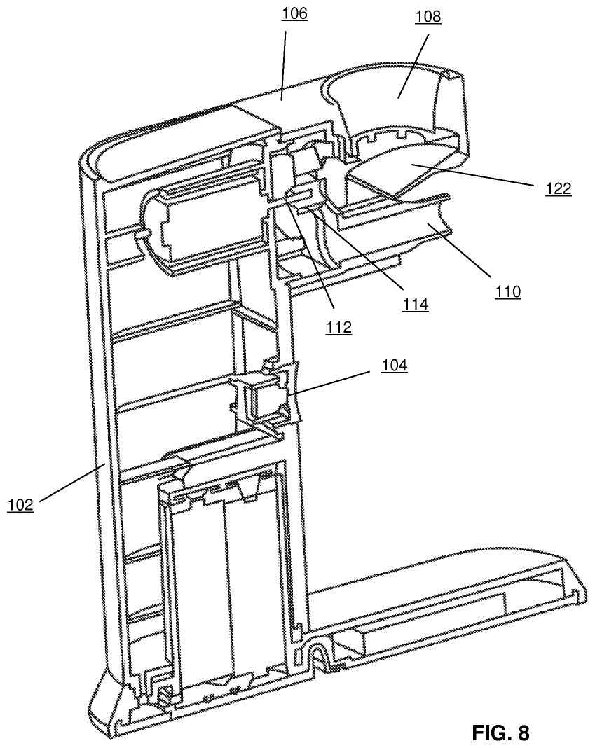

Referring to FIG. 8, a cutaway view of the entire infuser apparatus 100 is shown assembled together to show the placement of the internal components.

As can be seen from FIGS. 4, 6, 7, and 8, the fan unit and smoke inlet are in line with one another to generate efficient suction and create better airflow through the unit without turbulence.

The one or more fan blades of the fan unit may be formed of fibreglass.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the smoke infuser apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A smoke infuser apparatus, comprising:
a main housing;
a power unit disposed within the main housing;
a motor unit disposed within the main housing, the motor unit being connected to the power unit and configured to turn a shaft extending out of the main housing;
a control interface disposed on an exterior wall of the main housing for controlling a power supply from the power unit to the motor unit;
a fan unit configured to be mounted to the shaft; and
a detachable enclosure configured to attach to the main housing so as to cover the shaft-mounted fan unit, the enclosure comprising an exterior chamber configured to receive and hold combustible matter, the chamber having a perforated floor for smoke to flow through, the enclosure further comprising an inlet for receiving smoke from the chamber, an outlet for directing expelled smoke, and a U-shaped airway for directing a flow of smoke between the inlet and the outlet.

2. A smoke infuser apparatus according to claim 1, wherein the enclosure is formed of a first part configured to attach to the main housing to form a rear wall of the enclosure and a second part comprising the exterior chamber and configured to be mounted on the first part to form a front wall of the enclosure.

3. A smoke infuser apparatus according to claim 1, wherein the enclosure comprises an internally disposed platform underneath the perforated floor of the exterior chamber for catching burned matter.

4. A smoke infuser apparatus according to claim 1, wherein when installed upon the main housing, the smoke inlet of the enclosure, the fan unit, and the motor are in line with one another along a shared axis.

5. A smoke infuser apparatus according to claim 1, wherein the outlet forms a mount for a hosepipe, and wherein the apparatus further comprises a hosepipe configured to be mounted to the outlet.

6. A smoke infuser apparatus according to claim 5, wherein the hosepipe has a nozzle for directing a flow of expelled smoke.

7. A smoke infuser apparatus according to claim 1, wherein the perforated floor is a removable wire or metal mesh.

8. A smoke infuser apparatus according to claim 1, wherein the control interface consists of a power button.

9. A smoke infuser apparatus according to claim 8, wherein the motor is set to rotate the shaft at a single pre-determined speed upon actuation of the power button.

10. A smoke infuser apparatus according to claim 1, wherein one or more fan blades of the fan unit are formed of fibreglass.
